(19) United States
(12) Patent Application Publication
(10) Pub. No.: US 2013/0333150 A1
(43) Pub. Date: Dec. 19, 2013

(54) METHOD FOR PRODUCING WIPER BLADES AND WIPER BLADE FOR WIPING PANES

(71) Applicants: Ruddy Crabbe, Linter (Neerhespen) (BE); Wolfgang Endres, Baden-Baden (BE)

(72) Inventors: Ruddy Crabbe, Linter (Neerhespen) (BE); Wolfgang Endres, Baden-Baden (BE)

(73) Assignee: ROBERT BOSCH GMBH, Stuttgart (DE)

(21) Appl. No.: 14/001,524

(22) PCT Filed: Feb. 16, 2012
(86) PCT No.: PCT/EP12/52708

§ 371 Date: Aug. 26, 2013

(30) Foreign Application Priority Data
Feb. 24, 2011 (DE) 102011004628.3

(51) Int. Cl. B60S 1/38

(52) U.S. Cl. CPC B60S 1/38
USPC 15/250.361; 29/447

(57) ABSTRACT

The invention relates to a method for producing a wiper blades and to a wiper blade for wiping panes, in particular motor vehicle panes, comprising a support element (12) for receiving a wiper strip (14), to which a connecting device (20) is attached, which has a wiper blade-side part (15) having claw-like shoulders (50) surrounding the support element (12) at least in some regions. According to the invention, the wiper blade-side part (15) is pushed onto the support element with an only slightly larger inner width (44) than the thickness of the support element (12) and positioned, and is heat-treated after positioning.

### BACKGROUND OF THE INVENTION

In the case of wiper blades having a supporting element and a connection device, which is secured on the supporting element by means of a part on the wiper blade side, which has claw-type shoulders which engage around the supporting element, the supporting element is supposed to ensure as uniform as possible distribution of the wiper blade contact pressure emanating from the wiper arm against the window over the entire wiping area wiped by the wiper blade. By means of an appropriate curvature of the supporting element when under no load—i.e. when the wiper blade is not resting against the window—the ends of the wiper strip, which are laid fully on the window during the operation of the wiper blade, are subjected to a load in the direction of the window by the supporting element, which is then stressed, even though the radii of curvature of spherically curved vehicle windows differ at each wiper blade position. The curvature of the wiper blade must therefore be somewhat greater than the greatest curvature measured in the wiping area at the window to be wiped. A connection device, by means of which the connection with the wiper arm is established, is secured on the supporting element.

EP 0914269 B1 has disclosed the practice of securing the connection device on the supporting element by means of a welded joint. For this purpose, the connecting element on the wiper blade side, which is made of either metal or plastic, is applied to or to pushed onto the supporting element and connected materially to the supporting element, by means of a resistance weld in the case of a metal connecting element or by means of an ultrasonic weld in the case of a plastic connecting element. In everyday use, this welded joint is exposed to extreme conditions and must withstand high torque and vibration levels in different weather conditions. Especially in the case of wiper blades which are produced in large numbers, a welded joint makes high quality demands on process management and thus makes the wiper blade more expensive, which is precisely what needs to be avoided in the case of mass-produced goods.

### SUMMARY OF THE INVENTION

The method according to the invention for producing a wiper blade has the advantage that the wiper blade can be produced very economically. In general, the supporting element consists of drawn or rolled rails, which can be obtained within tight tolerances at no extra cost, while the part on the wiper blade side is a folded sheet-metal part or is injection molded. In this case too, the required tolerances can be achieved without problems. By virtue of the fact that heat treatment takes place after the assembly of the parts, however, it is not necessary to maintain very tight tolerances. The heat treatment ensures that the elements of the supporting element and of the part on the wiper blade side rest snugly against one another and produce at least a nonpositive joint. By means of appropriate surface characteristics and/or choice of material, it is also possible to ensure that the parts interlock or even bond adhesively to one another.

The heat treatment preferably acts on claw-type shoulders of the part on the wiper blade side, the shape and/or extent of which varies in such a way that they rest snugly against the supporting element.

If the heat treatment is applied to the supporting element, in particular to the lower side of the supporting element, the heat acts from the inside and therefore directly in the area of contact between the supporting element and the part on the wiper blade side and thus improves the joint.

Introducing the heat is particularly simple if it is directed at the locations to be heated in the form of blown hot air.

If it is necessary to introduce the heat as far as possible without any other influencing factors, the heat treatment can take place in the form of heat radiation. However, it is also possible, for example, to heat the supporting element inductively insofar as it is made of a metal and, in this way, to direct the heat selectively from the inside outward in a defined area.

If the heat treatment takes place by means of a hot plate, this can merely be held at a distance from the parts to be heated or, as an alternative, can enter into direct contact. In the latter case, it is possible to exert a shaping effect on the elements of the supporting element and/or of that part of the connection device which is on the wiper blade side and to improve the joint.

The heat treatment can take place very gently by means of a heating bath, through which at least the parts to be heated are drawn.

If as uniform as possible heating of the entire supporting element is to take place, the supporting element can be placed in a heating furnace.

Following the heat treatment, the heated parts are preferably subject to shaping, in particular being pressed onto one another. This reduces the gaps and results in a nonpositive and/or positive connection. Cooling of the heated parts may take place while they come into contact, and therefore a stepping shaping process is achieved.

The connection between the supporting element and that part of the connection device which is on the wiper blade side can be improved if a substance which hardens and/or swells and/or bonds adhesively during the heat treatment is introduced into the region between said parts. This substance can then embed itself in the smallest cracks and considerably improve the joint.

The application of that part of the connection device which is on the wiper blade side to the supporting element, in particular before the heat treatment, can be achieved in a particularly simple manner if the supporting element comprises or has two spaced spring rails, which are placed against one another before the part on the wiper blade side is pushed on and are adjusted to the specific spacing after the positioning of the part on the wiper blade side, that is to say, in particular, are pushed apart.

A wiper blade according to the invention for wiping windows, has the advantage that it can be produced in a very simple manner because the connection between the supporting element and that part of the connection device which is on the wiper blade side is significantly improved by a heat treatment in this region. This is particularly important because there are considerable torques between the supporting element and that part of the connection device which is on the wiper blade side during wiping operation, especially when the window is dry or when there is snow on the window. Moreover, these torques are not constant but alternate in a regular manner.

To ensure that the heat treatment works effectively, the clear width between the supporting element and that part of the connection device which is on the wiper blade side, the tolerance range should be from 0 mm to 0.5 mm, preferably from 0 mm to 0.2 mm, but at least from 0 mm to 0.05 mm.

The dimensional stability of the arrangement can be maintained in a simple manner if the spaced spring rails are covered at the ends thereof by end caps, wherein at least one end cap has a spacer.

Simple assembly is obtained if the connection device has run-on bevels in the region of the shoulders, thus ensuring that the spring rails can be threaded in in a simple manner in this region.

### BRIEF DESCRIPTION OF THE DRAWINGS

In the drawing:

FIG. 1 shows a wiper blade according to the invention in perspective representation with a wiper arm indicated in chain-dotted lines and a windscreen surface indicated in chain-dotted lines,

FIG. 2 shows a view according to II-II in FIG. 1,

FIG. 3 shows a schematic representation of the view shown in FIG. 2 with just one spring rail,

FIG. 4 shows a schematic view in direction of view IV in FIG. 1 with just one end cap,

FIG. 5 shows a schematic view, corresponding to FIG. 2, of an illustrative embodiment having a warm air blower,

FIG. 6 corresponds to FIG. 5 with a radiant heat source,

FIG. 7 corresponds to FIG. 5 with an induction heating unit,

FIG. 8 corresponds to FIG. 5 with a heating surface,

FIG. 9 corresponds to FIG. 5 in a heating furnace, and

FIG. 10 shows a schematic representation from the side of a wiper blade according to the invention in a heating bath.

### DETAILED DESCRIPTION

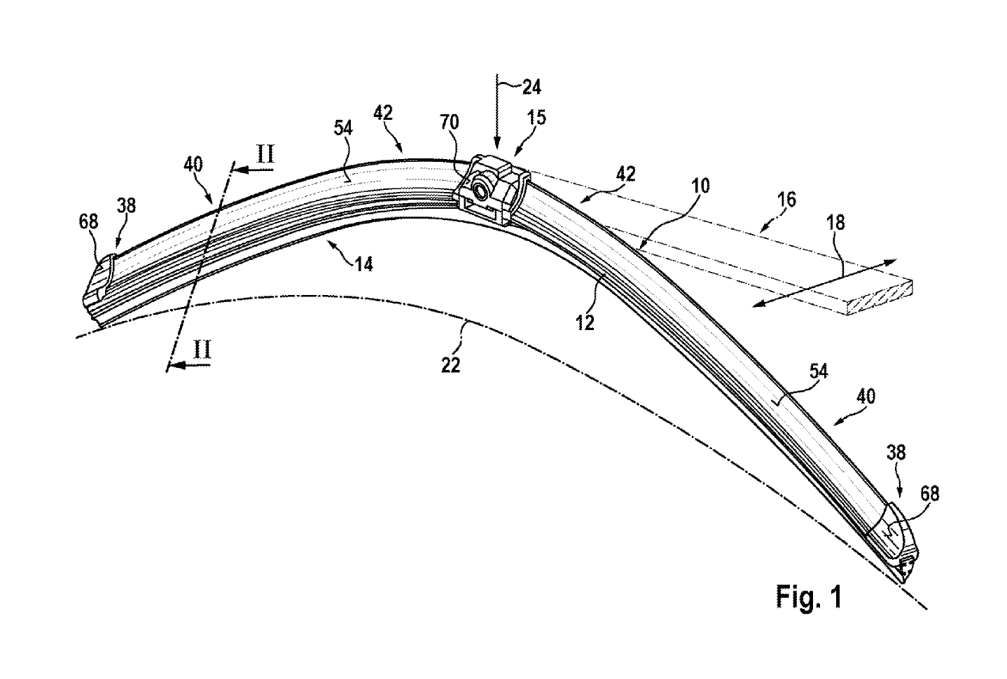

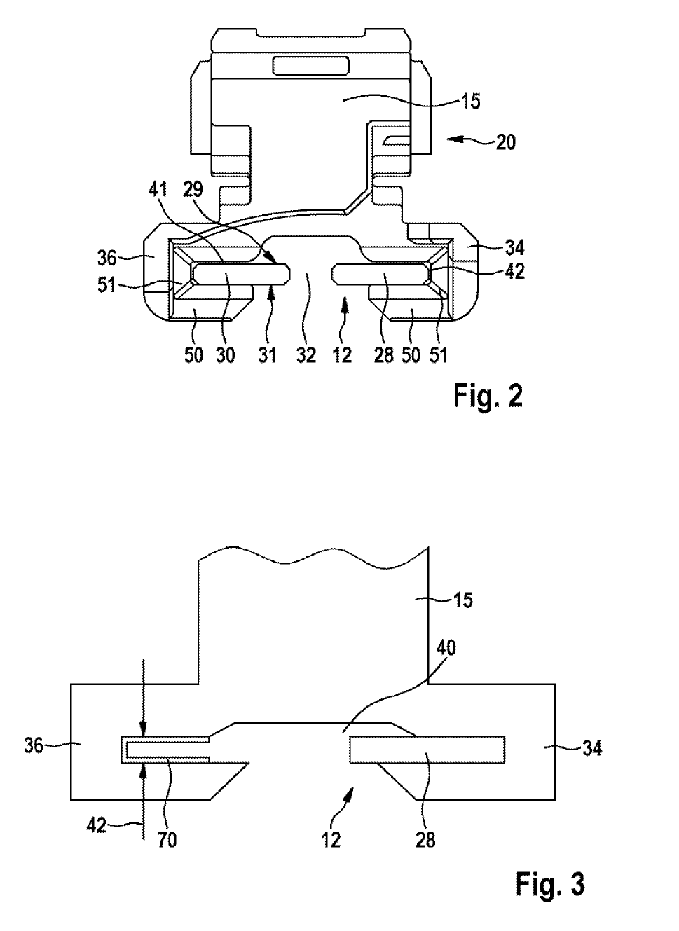

A wiper blade 10 shown in FIG. 1 has a supporting element 12 (FIGS. 1 and 2), which is elongated in the manner of a band, which has spring elasticity and on the lower band side 13 of which, that facing the window, an elongated wiper strip 14 having rubber elasticity is secured parallel to the longitudinal axis. Arranged on the upper band side 11, that facing away from the window, of the supporting element 12, which can also be referred to as a spring rail, in the central section of said supporting element, is that part 15 of a connection device which is on the wiper blade side, by means of which the wiper blade 10 can be releasably connected in an articulated manner to a wiper arm 16 indicated in chain-dotted lines in FIG. 1. The wiper arm 16, which is driven backwards and forwards in the direction of a double arrow 18 in FIG. 1, is loaded in the direction of arrow 24 toward the window to be wiped—e.g. toward the windscreen of a motor vehicle—the surface of which is indicated in FIG. 1 by a chain-dotted line 22. Since line 22 is intended to represent the greatest curvature of the window surface, it is clearly apparent that the curvature of the wiper blade resting by the two ends thereof against the window is greater while under no load than the maximum window curvature (FIG. 1). Under the contact pressure (arrow 24), the wiper blade 10 comes to rest over its entire length, by means of its wiping lip 26, against the window surface 22. At the same time, a stress builds up in the supporting element 12, which is made of metal and has spring elasticity, said stress ensuring proper contact between the wiper strip 14 or the wiping lip 26 and the window surface 22 over the entire length of said strip or lip and also ensuring uniform distribution of the contact pressure (arrow 24).

The particular embodiment of the wiper blade according to the invention will be explained in greater detail below.

In FIG. 2, it can be seen that the supporting element 12 is constructed from two mutually separate spring strips 28 and 30, which are spaced apart and form the basis of a gap 32. In a lower region, the connection device 15 has two u-shaped receptacles 34 and 36, in which the spring strips 28 and 30 are received. The receptacles 34 and 36 surround each of the spring strips 28 and 30 over a relatively large proportion of the cross section thereof, wherein that part of the connection device 15 which corresponds to the wiper arm 16 is arranged on the convex side 29 of the supporting element 12, while the concave side 31 lies opposite said convex side. There is a small gap 41 between the spring strips 28, 30 and the respective receptacles 34, 36.

In FIG. 3, the connection device 15 is illustrated schematically, wherein the corresponding spring strip 28 is depicted in receptacle 34, while spring strip 30 is not in the corresponding receptacle 36, allowing the clear width 42 to be seen. It can be seen that receptacles 34 and 36 fit around spring strips 28 and 30, and further details of the existing tolerances will be given later. In the region above spring strips 28 and 30 and above the gap 32, the connection device 15 has a recess 40, in which a head part of a wiper strip 14 comes to rest when the wiper blade 10 is assembled.

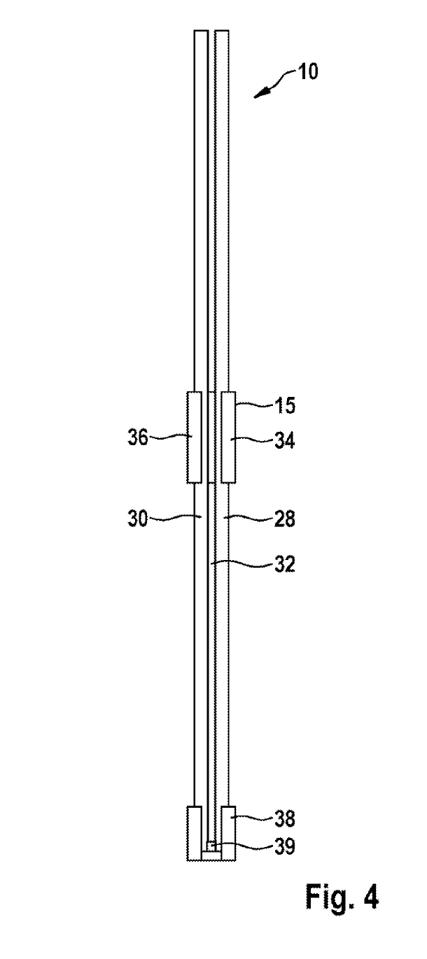

The wiper blade 10, which is shown from below in FIG. 4 and is depicted without the wiper strip 14 or wiper lip 26, shows spring strips 28 and 30, the gap 32 and receptacles 34 and 36 of the connection device 15. It can be seen that, in this embodiment of the wiper strip 10, spring strips 28 and 30 are completely separated from one another and are only held together by the connection device 15 or by means of the end caps 38, of which only one is depicted at one end in FIG. 4. At least one of the end caps 38 has a spacer 39, which holds spring strips 28, 30 at the spacing of the gap 32 in the assembled state.

In the method according to the invention, that part 15 of the connection device 20 which is on the wiper blade side is then pushed onto the supporting element 12, for which purpose the part 15 on the wiper blade side has a clear width 42 in the region of receptacles 34, 36 which is the same as or slightly greater than the thickness of spring strips 28, 30. For this purpose, the clear width is approximately 0 mm to at least 0.05 mm greater than the thickness of spring strips 28, 30. Assembly is simpler if the permitted tolerance range is in a range of from 0 mm to 0.2 mm, although in that case increased demands have to be made on the heat treatment. Very simple assembly can be accomplished if the tolerance range is between 0 mm and 0.5 mm, in which case it can be assumed that additional measures will be necessary to reduce the gap after the heat treatment. In the case of small gaps 41, in particular, mounting of the part 15 on the wiper blade side on spring strips 28, 30 must be performed in such a way that spring strips 28, 30 are held next to one another in the clear widths, with the gap 32 being reduced, the part 15 on the wiper blade side is pushed on, and only then are spring strips 28, 30 adjusted to the spacing 32 and thus pushed into the receptacles. Of course, this method can also be advantageous in the case of different tolerances.

In order to facilitate the introduction of the part on the wiper blade side and spring rails 28, 30 into one another, receptacles 34, 36 have run-on bevels 51 in the region of the claw-type shoulders 50.

As soon as the supporting element 12 and the part 15 on the wiper blade side have adopted the correct position relative to one another, a heat treatment is begun, being directed either at the part 15 on the wiper blade side or at the supporting element 12 or even at both elements. As a result, there is a change in the clear width 42 such that it completely or at least largely closes the gap 41.

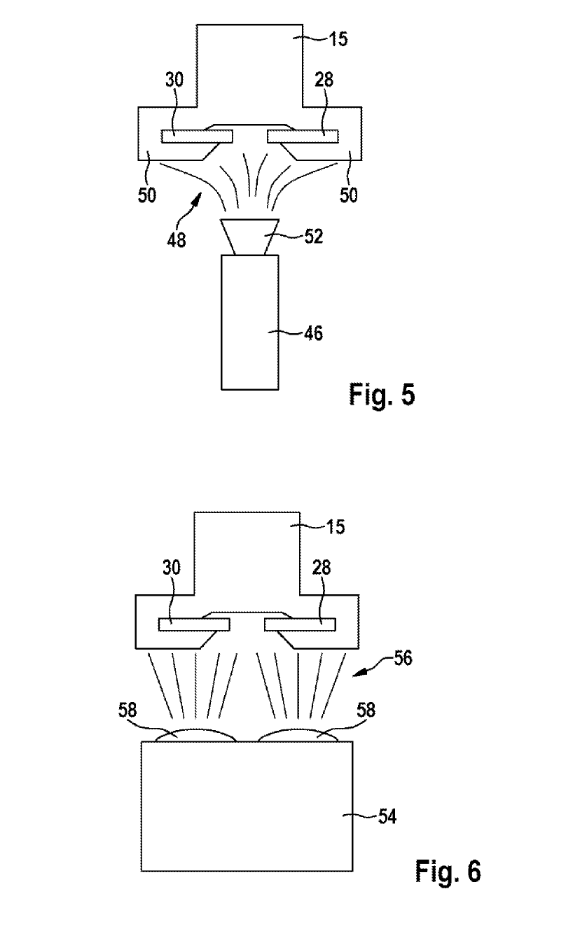

FIG. 5 illustrates how a hot air stream 48 is blown from below at receptacles 34 and 36 or directly at claw-type shoulders 50 by means of a hot air blower 46. For this purpose, the hot air blower 46 has a directional device 52, which is designed in a funnel shape in the illustrative embodiment. The hot air stream 48 is thereby directed simultaneously at both claw-type shoulders 50, at the spring strips 28, 30 projecting in the gap 32, and into the recess 40. The entire region is thus heated uniformly.

The length of the hot air blower 46 can be matched to the length of the part 15 on the wiper blade side, when viewed in the longitudinal direction of the wiper blade, or, alternatively, it can be kept smaller and moved in the longitudinal direction.

In another illustrative embodiment, shown in FIG. 6, a radiant heater 54 is shown as a heat source, radiant heat 56 being directed from said heater at the lower region of the wiper blade 10. In the illustrative embodiment, the radiant heat 56 is produced by two radiant heaters 58 of the kind used, for example, in “reflow furnaces” during soldering. Compared with the hot air stream 48, the radiant heat 56 has the advantage that no swirling or turbulence and hence no forces on the wiper blade 10 arise. However, it can be disadvantageous that, overall, the heat acts only directly from below, whereas the hot air stream 48 can propagate right into the recess 40.

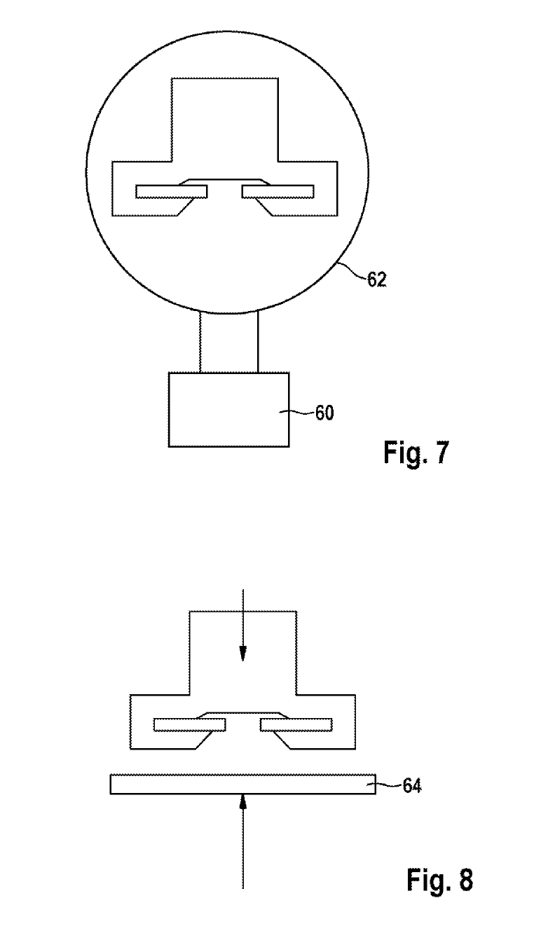

An illustrative embodiment shown in FIG. 7 takes a different approach, in which the heat is produced in the metal spring strips 28, 30 of the supporting element 12 by means of an induction device 60. For this purpose, the already assembled ensemble consisting of spring strips 28, 30 and the part 15 on the wiper blade side is moved through an induction loop 62, or the induction loop 62 is guided over the ensemble while a high frequency alternating current is applied to the induction loop 62, which is preferably designed as a coil.

FIG. 8 once again illustrates the already assembled ensemble consisting of spring strips 28, 30 and the part 15 on the wiper blade side, under which a hot plate 64 is positioned. If a spacing is maintained between the plate 64 and the claw-type shoulders 50, the heat is transferred by means of heat radiation, in a manner similar to that in the illustrative embodiment shown in FIG. 6. However, it is also possible to forcibly press the plate 64 onto the claw-type shoulders 50, giving rise, in addition to the heating, to a shaping pressure which closes the gap 41 or the gaps 41.

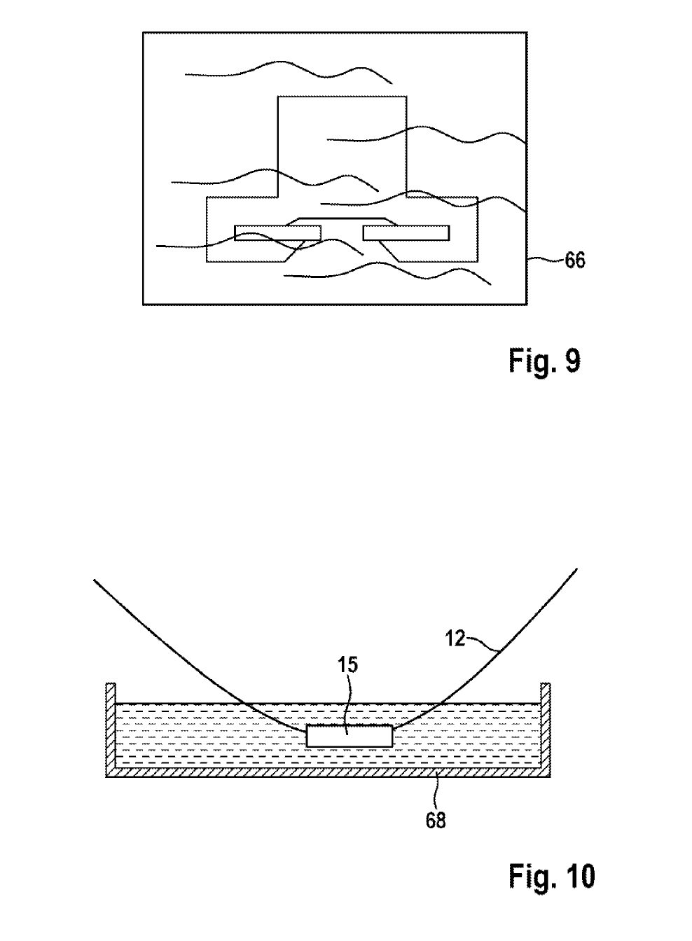

In FIG. 9, the assembled ensemble consisting of spring strips 28, 30 and the part 15 on the wiper blade side is positioned in a heating furnace 66, in which a defined atmosphere can prevail. In FIG. 10, the assembled ensemble consisting of spring strips 28, 30 and the part 15 on the wiper blade side is immersed in a heating bath 68.

Depending on the manner in which the heat is introduced and/or the manner in which spring strips 28, 30 and the part 15 on the wiper blade side are prepared, the gaps 41 may close spontaneously or may require closure by the expenditure of additional force. If this further step is necessary, then, in the simplest case, a plate heated to a greater or lesser extent can be pressed in on the part 15 on the wiper blade side, as can be seen in the example shown in FIG. 8. The plate can have a temperature which introduces additional heat, or a cooling process can be set in train even at this stage. By means of the cooling, a permanent change in shape is achieved.

In all the methods according to the illustrative embodiments, it is possible to introduce an additional substance 70 into the clear width 42, which hardens and/or swells and/or adhesively bonds spring strips 28, 30 to the part 15 on the wiper blade side during the heat treatment.

1. A method for producing a wiper blade having a supporting element (12) and a connection device (20), which is secured on the supporting element (12) by means of a part (15) on a wiper blade side, which has claw-type shoulders (50) which engage around the supporting element (12), at least in some region or regions, characterized in that the part (15) on the wiper blade side is pushed onto and positioned on the supporting element (12) with only a slightly larger clear width (42) than a thickness of the supporting element (12) and is heat treated after positioning.

2. The method as claimed in claim 1, characterized in that the heat treatment acts on the claw-type shoulders (50) from a lower side.

3. The method as claimed in claim 1, characterized in that the heat treatment acts on the supporting element (12) from a lower side.

4. The method as claimed in claim 1, characterized in that the heat treatment takes place in the form of blown hot air (48).

5. The method as claimed in claim 1, characterized in that the heat treatment takes place in the form of heat radiation (56).

6. The method as claimed in claim 1, characterized in that the heat treatment takes place in inductive form (60, 62).

7. The method as claimed in claim 1, characterized in that the heat treatment takes place by means of a hot plate (64).

8. The method as claimed in claim 1, characterized in that the heat treatment takes place by means of a heating bath (68).

9. The method as claimed in claim 1, characterized in that the supporting element (12) is transferred to a heating furnace (66) for the heat treatment.

10. The method as claimed in claim 1, characterized in that the shoulders (50) are pressed during or after the heat treatment.

11. The method as claimed in claim 1, characterized in that, after the heat treatment, the shoulders (50) are pressed and cooled by a cooling device.

12. The method as claimed in claim 1, characterized in that a substance (70) which hardens and/or swells and/or bonds adhesively during the heat treatment is introduced into the clear width (42).

13. The method as claimed in claim 1, characterized in that the supporting element (12) has two spaced spring rails (28, 30), which are placed against one another before the part (15) on the wiper blade side is pushed on and are adjusted to a correct spacing (32) after the positioning of the part (15) on the wiper blade side.

14. A wiper blade for wiping windows, having a supporting element (12) for receiving a wiper strip (14), on which is secured a connection device (20), which has a part (15) on a wiper blade side with claw-type shoulders (50) which engage around the supporting element (12), at least in some region or regions, characterized in that the shoulders (50) have a clear width (42) which corresponds substantially to or is slightly greater than a thickness of the supporting element (12), and in that securing of the part (15) on the wiper blade side on the supporting element (12) is improved by a heat treatment acting at least on the shoulders (50).

15. The wiper blade as claimed in claim 14, characterized in that the clear width (42) is within a tolerance range of from 0 mm to 0.5 mm, greater than the thickness of the supporting element (12).

16. The wiper blade as claimed in claim 14, characterized in that the supporting element (12) has two spaced spring rails (28, 30), ends of which are each covered by an end cap (38), wherein at least one end cap (38) has a spacer (39).

17. The wiper blade as claimed in claim 14, characterized in that the connection device (20) has run-on bevels (51) in the region of the shoulders (50).

18. A wiper blade for wiping windows, having a supporting element (12) for receiving a wiper strip (14), on which is secured a connection device (20), which has a part (15) on a wiper blade side with claw-type shoulders (50) which engage around the supporting element (12), at least in some region or regions, produced the method of claim 1, characterized in that the shoulders (50) have a clear width (42) which corresponds substantially to or is slightly greater than the thickness of the supporting element (12), and in that the securing of the part (15) on the wiper blade side on the supporting element (12) is improved by a heat treatment acting at least on the shoulders (50).

19. The wiper blade as claimed in claim 14, characterized in that the clear width (42) is within a tolerance range of from 0 mm to 0.2 mm greater than the thickness of the supporting element (12).

20. The wiper blade as claimed in claim 14, characterized in that the clear width (42) is within a tolerance range of at least from 0 mm to 0.05 mm greater than the thickness of the supporting element (12).
